(19) United States
(12) Patent Application Publication
(10) Pub. No.: US 2024/0139856 A1
(43) Pub. Date: May 2, 2024

(54) METHOD FOR VACUUM ELECTRON BEAM WELDING OF TWINNING-INDUCED PLASTICITY (TWIP) STEEL AND USE THEREOF

(71) Applicant: Hefei Institute of Physical Science, Chinese Academy of Sciences, Hefei (CN)

(72) Inventors: Zhihong Liu, Hefei (CN); Jianguo Ma, Hefei (CN); Zhenfei Liu, Hefei (CN); Haoxiang Deng, Hefei (CN); Xingfu Wang, Hefei (CN); Jiefeng Wu, Hefei (CN)

(21) Appl. No.: 18/243,090

(22) Filed: Sep. 6, 2023

(30) Foreign Application Priority Data
Nov. 1, 2022 (CN) 202211353340.3

(51) Int. Cl. B23K 15/00; B23K 15/06

(52) U.S. Cl. CPC B23K 15/0093; B23K 15/0033; B23K 15/06; B23K 2103/04

(57) ABSTRACT

Disclosed is a method for vacuum electron beam welding of twinning-induced plasticity (TWIP) steel and use thereof. The welding method according to the present disclosure includes preheating welding, tack welding, and deep penetration welding. The method according to the present disclosure can achieve welding stability, a uniform butt joint width, small splash and full arc ending, and ensure that the internal quality of a welded joint meets requirements for an ISO13919-1 grade B butt joint, and the plasticity and tensile strength of the welded joint are equivalent to those of a base metal, thereby ensuring that the welded joint has a high energy-absorbing buffering function equivalent to that of a base metal. A vehicle anti-collision beam manufactured after welding and a vehicle energy-absorbing buffer component assembled by using the anti-collision beam have the advantages of light structure, high safety protection, etc.

### CROSS REFERENCE TO RELATED APPLICATIONS

The present application claims the benefit of Chinese Patent Application No. 202211353340.3 filed on Nov. 1, 2022. All the above are hereby incorporated by reference in their entirety.

### TECHNICAL FIELD

The present disclosure relates to the technical field of manufacturing processes of a lightweight energy-absorbing buffer component of a vehicle, and in particular, to a method for vacuum electron beam welding of twinning-induced plasticity (TWIP) steel and use thereof.

### BACKGROUND

Lightweight design of an anti-collision and energy-absorbing buffer component of a vehicle is the direction that people have been pursuing and developing currently. TWIP steel features high strength, high plasticity, light weight and high impact energy absorption, and is a type of steel under hot research currently.

However, for high-carbon high-manganese TWIP steel, when a conventional welding method, such as argon arc welding, is used, this high heat input welding method may expand a heat affected zone of a welded joint and seriously damage the plasticity and strength of the welded joint. In this case, a welded component cannot meet actual requirements for the plasticity and strength of the welded joint, which limits the application of the high-carbon high-manganese TWIP steel in the fields of energy absorption and buffering of vehicles and the like. Therefore, there is currently an urgent need to develop a novel welding technology to enable performance of a high-carbon and high-manganese TWIP steel workpieces to meet requirements of more fields.

### SUMMARY

In view of the problems of poor plasticity, low strength, etc. of a welded joint made of TWIP steel in the prior art, the present disclosure provides a method for vacuum electron beam welding of TWIP steel and use thereof.

To achieve the above objective, the following technical solution is specifically adopted: A method for vacuum electron beam welding of TWIP steel includes the following steps:
(1) welding preparation, including: placing butt-jointed TWIP steel workpieces in a vacuum chamber of a welding machine, and vacuumizing the vacuum chamber of the welding machine until a vacuum degree in the vacuum chamber is less than 1×10⁻⁴ mbar;
(2) preheating welding, including: performing electron beam defocus preheating on a butt joint of the TWIP steel workpieces, where the electron beam defocus preheating process is carried out with the following parameters: a welding speed of 5-10 mm/s, a focused beam current of 2,300-2,600 mA, an electron beam current of 10-30 mA, electron beam deflection scanning in a sine wave mode with a scanning amplitude of 2-5 mm and a frequency of 500-1,000 Hz, and an accelerating voltage of 150 kV;
(3) tack welding, including: performing symmetrical tack welding on a butt joint of the TWIP steel workpieces subjected to the preheating welding, where the symmetrical tack welding process is carried out with the following parameters: a welding speed of 5-15 mm/s, a focused beam current of 2,100-2,400 mA, an electron beam current of 2-5 mA, and an accelerating voltage of 150 kV;
(4) deep penetration welding: performing deep penetration welding on the butt joint of the TWIP steel workpieces subjected to the tack welding, where the deep penetration welding process is carried out with the following parameters: a welding speed of 5-15 mm/s, a focused beam current of 2,050-2,350 mA, an electron beam current of 5-50 mA, electron beam deflection scanning in a circular wave mode with a scanning amplitude of 0.5-2 mm and a frequency of 50-1,000 Hz, and an accelerating voltage of 150 kV; and
(5) cooling the TWIP steel workpieces subjected to the deep penetration welding to obtain a welded molded part.

According to the present disclosure, vacuum electron beam welding is adopted to weld the TWIP steel workpieces. The vacuum electron beam welding features a high energy density, a large butt joint depth-width ratio and a narrow heat affected zone of a welded joint. In addition, according to the present disclosure, parameters of the welding process are further regulated and controlled, so that the welding process is stable, and finally a welded molded part with a uniform butt joint structure, high internal quality of the butt joint and high tensile strength and plasticity of the weld joint is obtained.

In a preferred implementation of the present disclosure, the chemical composition of the TWIP steel workpieces in step (1) is as follows: by mass percentage, 0.6%-0.9% of C, 20%-30% of Mn, 0.3%-1.0% of Si, 0.3%-1.0% of Al, ≤0.015% of P, ≤0.005% of S, 0.3%-0.6% of V, 0.2%-0.5% of Nb, ≤0.1% of impurities, and the balance Fe.

Steel of the TWIP steel workpieces in step (1) is ultrahigh manganese TWIP steel, a specific preparation method is shown in the patent document with a publication number of CN 112695258 A, and the steel is high-carbon and high-manganese TWIP steel, with the main chemical components as follows: Fe, 0.6%-0.9% of C, 20%-30% of Mn, 0.3%-1.0% of Si, and 0.3%-1.0% of Al.

In a further preferred implementation of the present disclosure, the chemical composition of the TWIP steel workpieces in step (1) is as follows: by mass percentage, 0.7% of C, 20% of Mn, 0.5% of Si, 0.3% of Al, ≤0.015% of P, ≤0.005% of S, 0.3% of V, 0.2% of Nb, ≤0.1% of impurities, and the balance Fe.

The method according to the present disclosure can achieve welding stability, a uniform butt joint width, small splash and full arc ending, and ensure that the internal quality of a welded joint meets requirements for a ISO13919-1 grade B butt joint, and the plasticity and tensile strength of the welded joint are equivalent to those of a base metal, thereby ensuring that the welded joint has a high energy-absorbing buffering function equivalent to that of a base metal.

In a preferred implementation of the present disclosure, the TWIP steel workpieces in step (1) have a thickness of 2-10 mm, a length of 100-200 mm and a width of 100-200 mm.

In a further preferred implementation of the present disclosure, the TWIP steel workpieces in step (1) have a thickness of 8 mm, a length of 150 mm and a width of 150 mm.

In a preferred implementation of the present disclosure, in step (1), the workpieces are butt-jointed in an I-shaped butt joint, and a gap of the butt joint does not exceed 0.1 mm.

The I-shaped butt joint is an I-shaped joint achieved by the workpieces abutting against each other.

In a preferred implementation of the present disclosure, in step (2), the electron beam defocus preheating process is carried out with the following parameters: a welding speed of 10 mm/s, a focused beam current of 2,510 mA, an electron beam current of 10 mA, a scanning amplitude of 4 mm, and a frequency of 600 Hz.

The objective of the preheating welding is to control the temperature of the butt joint zone to 80-150° C., which can ensure the effective overflow of hydrogen in the butt joint, reduce the splash during welding, ensure a uniform butt joint width, reduce heat input of subsequent welding, and further reduce the heat affected zone of the welded joint.

In a preferred implementation of the present disclosure, in step (3), the symmetrical tack welding process is carried out with the following parameters: a welding speed of 10 mm/s, a focused beam current of 2,310 mA, and an electron beam current of 3 mA.

In a preferred implementation of the present disclosure, in step (4), the deep penetration welding process is carried out with the following parameters: a welding speed of 10 mm/s, a focused beam current of 2300 mA, an electron beam current of 20 mA, a scanning amplitude of 0.8 mm, and a frequency of 200 Hz.

In a preferred implementation of the present disclosure, in steps (2)-(4), an interval between the preheating welding, the tack welding and the deep penetration welding is 5-15 min.

In a preferred implementation of the present disclosure, in steps (2)-(4), an interval between the preheating welding, the tack welding and the deep penetration welding is 10 min.

After the above time interval, the butt joint temperature can be effectively homogenized, and it is ensured that the butt joint temperature is not less than 80° C., thereby reducing welding deformation and improving performance of the workpieces.

In a preferred implementation of the present disclosure, the cooling in step (5) is performed for 60-480 min.

In a further preferred implementation of the present disclosure, the cooling in step (5) is performed for 60 min.

Use of a welded molded part made by using the method for vacuum electron beam welding of the TWIP steel in a lightweight energy-absorbing buffer component of a vehicle is provided. The welded molded part made of the high-carbon and high-manganese TWIP steel by using the welding method according to the present disclosure can play an effective buffer function as an anti-collision beam.

Compared with the prior art, the present disclosure has the following beneficial effects: the method according to the present disclosure can achieve welding stability, a uniform butt joint width, small splash and full arc ending, and ensure that the internal quality of a welded joint meets requirements for an ISO13919-1 grade B butt joint, and the plasticity and tensile strength of the welded joint are equivalent to those of a base metal, thereby ensuring that the welded joint has a high energy-absorbing buffering function equivalent to that of a base metal. A vehicle anti-collision beam manufactured after welding and a vehicle energy-absorbing buffer component assembled by using the anti-collision beam have the advantages of light structure, high safety protection, etc.

### BRIEF DESCRIPTION OF THE DRAWINGS

FIG. 1 shows a front morphology of a butt joint of a welded molded part in Example 1 of the present disclosure;

FIG. 2 shows a cross-section morphology of the butt joint of the welded molded part in Example 1 of the present disclosure;

FIG. 3 shows a result of X-ray flaw detection of a butt joint of the welded molded part in Example 1 of the present disclosure;

FIG. 4 shows a specimen that was fractured in a transverse mechanical tensile test of the butt joint of the welded molded part in Example 1 of the present disclosure; and

FIG. 5 shows transverse mechanical tensile test results of the butt joint of the welded molded part (solid line) and a base metal (dotted line) in Example 1 of the present disclosure.

### DETAILED DESCRIPTION

In order to better illustrate the objectives, technical solutions, and advantages of the present disclosure, the present disclosure will be further described below by means of a specific comparative example and examples.

TWIP steel workpiece of Examples of the present disclosure and the comparative example are made of ultrahigh manganese TWIP steel, which has the following chemical composition: by mass percentage, 0.6%-0.9% of C, 20%-30% of Mn, 0.3%-1.0% of Si, 0.3%-1.0% of Al, ≤0.015% of P, ≤0.005% of S, 0.3%-0.6% of V, 0.2%-0.5% of Nb, ≤0.1% of impurities, and the balance Fe. For a specific method for preparing the ultrahigh manganese TWIP steel, reference may be made to the patent document titled METHOD FOR LARGE-CAPACITY SMELTING AND COMPOSITION CONTROL OF ULTRAHIGH MANGANESE TWIP STEEL, with the publication number of CN 112695258 A. The chemical composition of steel of a workpiece to be welded in Examples 1-3 and Comparative Example 1 is: by mass percentage, 0.7% of C, 20% of Mn, 0.5% of Si, 0.3% of Al, ≤0.015% of P, ≤0.005% of S, 0.3% of V, 0.2% of Nb, ≤0.1% of impurities, and the balance Fe. For a specific preparation method, reference may be made to Example 1 of the patent document with the publication number of CN 112695258 A.

### Example 1

In this example, two pieces of ultrahigh manganese TWIP steel were in butt joint as workpieces to be welded for vacuum electron beam welding. Before welding, the two pieces of ultrahigh manganese TWIP steel were in an annealed state, with a thickness of 8 mm, a length of 150 mm and a width of 150 mm.

The welding requirements were as follows: The weld penetration depth was greater than 8 mm.

A matching material was a backing plate, and the backing plate was made of the same material as the workpiece to be welded and was in an annealed state, with a thickness of 9 mm, a length of 150 mm and a width of 8 mm.

(1) Fine sandpaper dipped in alcohol was used to polish a butt joint to be welded and metal surfaces within the range of 40 mm around the butt joint to expose metallic luster, then the workpieces to be welded were cleaned with water, and the surfaces of the workpieces to be welded were wiped with a silk fabric dipped in alcohol to ensure that the metal surfaces were free of impurities such as oil stains.

(2) The workpieces to be welded were in butt joint and compressed to ensure that a gap between the two workpieces was not greater than 0.1 mm, thereby implementing an I-shaped joint. The backing plate was placed on the back of the butt joint and compressed together.

(3) Welding preparation: The butt-jointed and compressed workpieces to be welded were placed in a vacuum chamber of a welding machine, and the vacuum chamber of the welding machine was vacuumized to make a vacuum degree in the vacuum chamber less than 1×10⁻⁴ mbar.

(4) Preheating welding: Electron beam defocusing preheating was performed on the butt joint to be welded, where a welding speed during preheating was 10 mm/s, a focused beam current was 2,510 mA, an electron beam current was 10 mA, electron beam deflection scanning was performed in a sine wave mode with a scanning amplitude of 4 mm and a frequency of 600 Hz, and an accelerating voltage was 150 kV.

(5) Tack welding: Waiting was performed for 10 min after the preheating welding, and symmetrical tack welding was performed on the butt joint to be welded, where a welding speed during tack welding was 10 mm/s, a focused beam current was 2,310 mA, an electron beam current was 3 mA, there was no scanning waveform, and an accelerating voltage was 150 kV.

(6) Deep penetration welding: Waiting was performed for 10 min after the tack welding, and then deep penetration welding was performed on the butt joint to be welded, where a welding speed of the deep penetration welding was 10 mm/s, a focused beam current was 2,300 mA, an electron beam current was 20 mA, electron beam deflection scanning was performed in a circular wave mode with a scanning amplitude of 0.8 mm and a frequency of 200 Hz, and an accelerating voltage was 150 kV.

(7) A welded molded part was cooled in the vacuum chamber for at least 60 min, and then vacuumized to obtain a welded molded part.

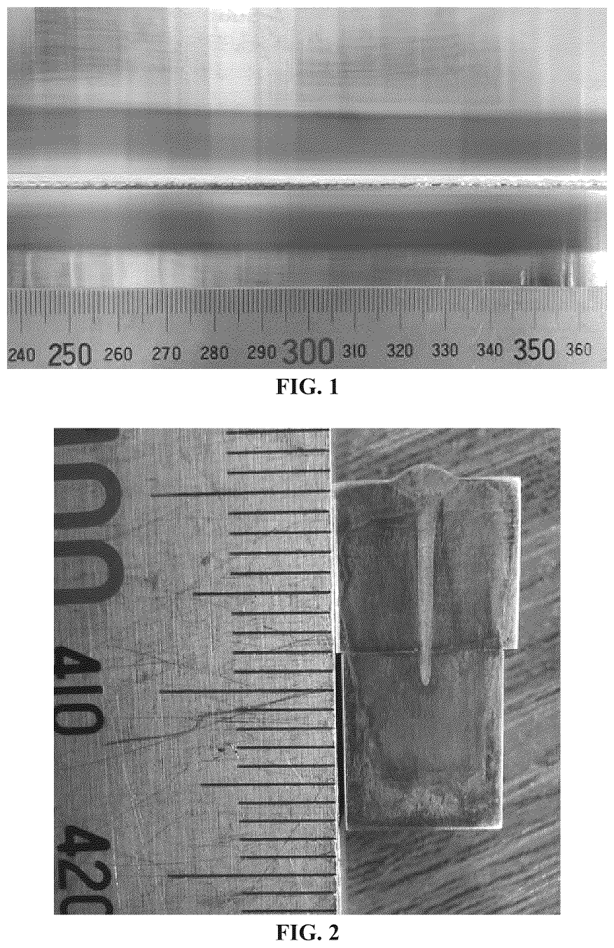

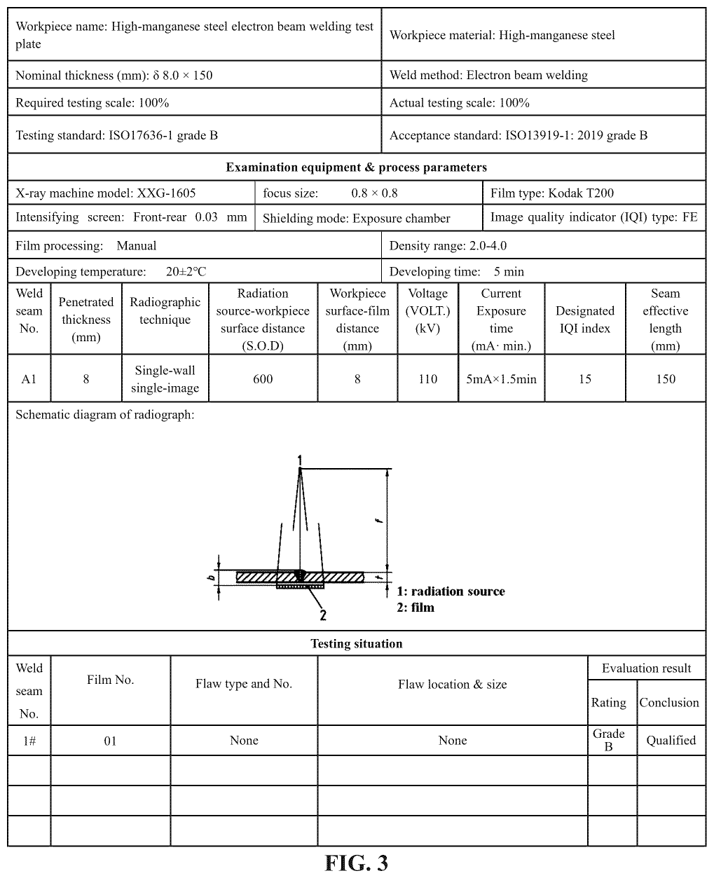

The butt joint morphology of the above welded molded part is shown in FIG. 1 and FIG. 2, and it can be observed that there was no crack on the surface of the welded molded part, and there was no crack, undercut or slump occurring to the butt joint.

After X-ray flaw detection of the butt joint of the welded molded part, the results are shown in FIG. 3. It is found that the butt joint has no internal quality defects such as blowholes and cracks, and the butt joint grade meets ISO13919-1 grade B requirements.

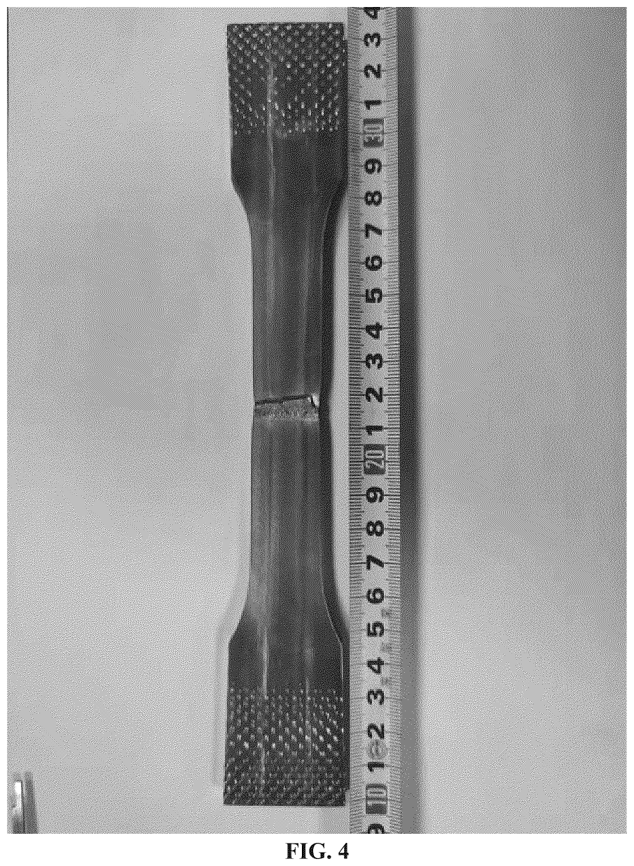

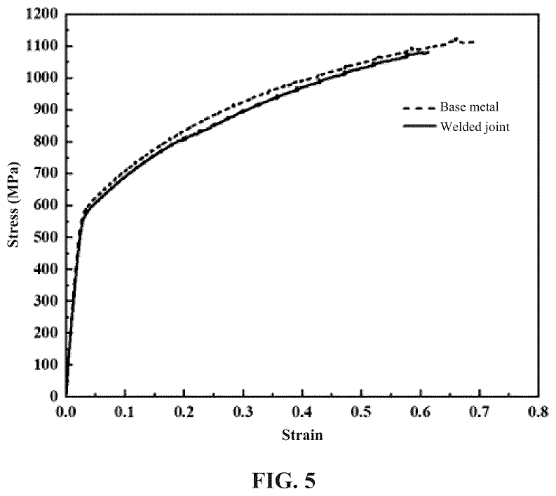

A specimen of the butt joint (as shown in FIG. 4) was taken according to GB/T2651-2008, and compared with a base metal (i.e., an unwelded ultrahigh manganese TWIP steel plate), and a transverse mechanical tensile test was performed. As shown in FIG. 5, the tensile strength of this welded butt joint was 1,080 MPa, and the elongation after fracture was 50.62%; the tensile strength of the base metal was 1,125 MPa, and the elongation after fracture was 65%. Therefore, it can be seen that the plasticity and tensile strength of the welded joint prepared by using the welding method according to the present disclosure are equivalent to those of the base metal, and it is ensured that the welded joint has a high energy-absorbing buffering function equivalent to that of the base metal.

In this example, the welded molded part made of ultrahigh manganese TWIP steel made by the using the above welding method is made into an anti-collision beam of a vehicle, and an energy-absorbing buffer component assembled by using the anti-collision beam has the advantages of light structure, high safety protection, etc.

### Example 2

In this example, two pieces of ultrahigh manganese TWIP steel were in butt joint as workpieces to be welded for vacuum electron beam welding. Before welding, the two pieces of ultrahigh manganese TWIP steel were in an annealed state, with a thickness of 8 mm, a length of 150 mm and a width of 150 mm.

The welding requirements were as follows: The weld penetration depth was greater than 8 mm.

A matching material was a backing plate, and the backing plate was made of the same material as the workpiece to be welded and was in an annealed state, with a thickness of 9 mm, a length of 150 mm and a width of 8 mm.

(1) Fine sandpaper dipped in alcohol was used to polish a butt joint to be welded and metal surfaces within the range of 40 mm around the butt joint to expose metallic luster, then the workpieces to be welded were cleaned with water, and the surfaces of the workpieces to be welded were wiped with a silk fabric dipped in alcohol to ensure that the metal surfaces were free of impurities such as oil stains.

(2) The workpieces to be welded were in butt joint and compressed to ensure that a gap between the two workpieces was not greater than 0.1 mm, thereby implementing an I-shaped joint. The backing plate was placed on the back of the butt joint and compressed together.

(3) Welding preparation: The butt-jointed and compressed workpieces to be welded were placed in a vacuum chamber of a welding machine, and the vacuum chamber of the welding machine was vacuumized to make a vacuum degree in the vacuum chamber less than 1×10⁻⁴ mbar.

(4) Preheating welding: Electron beam defocusing preheating was performed on the butt joint to be welded, where a welding speed during preheating was 5 mm/s, a focused beam current was 2600 mA, an electron beam current was 30 mA, electron beam deflection scanning was performed in a sine wave mode with a scanning amplitude of 2 mm and a frequency of 1000 Hz, and an accelerating voltage was 150 kV.

(5) Tack welding: Waiting was performed for 15 min after the preheating welding, and symmetrical tack welding was performed on the butt joint to be welded, where a welding speed during tack welding was 5 mm/s, a focused beam current was 2400 mA, an electron beam current was 5 mA, and an accelerating voltage was 150 kV.

(6) Deep penetration welding: Waiting was performed for 15 min after the tack welding, and then deep penetration welding was performed on the butt joint to be welded, where a welding speed of the deep penetration welding was 15 mm/s, a focused beam current was 2350 mA, an electron beam current was 10 mA, electron beam deflection scanning was performed in a circular wave mode with a scanning amplitude of 2 mm and a frequency of 800 Hz, and an accelerating voltage was 150 kV.

(7) A welded molded part was cooled in the vacuum chamber for at least 60 min, and then vacuumized to obtain a welded molded part.

### Example 3

In this example, two pieces of ultrahigh manganese TWIP steel were in butt joint as workpieces to be welded for vacuum electron beam welding. Before welding, the two pieces of ultrahigh manganese TWIP steel were in an annealed state, with a thickness of 8 mm, a length of 150 mm and a width of 150 mm.

The welding requirements were as follows: The weld penetration depth was greater than 8 mm.

A matching material was a backing plate, and the backing plate was made of the same material as the workpiece to be welded and was in an annealed state, with a thickness of 9 mm, a length of 150 mm and a width of 8 mm.

(1) Fine sandpaper dipped in alcohol was used to polish a butt joint to be welded and metal surfaces within the range of 40 mm around the butt joint to expose metallic luster, then the workpieces to be welded were cleaned with water, and the surfaces of the workpieces to be welded were wiped with a silk fabric dipped in alcohol to ensure that the metal surfaces were free of impurities such as oil stains.

(2) The workpieces to be welded were in butt joint and compressed to ensure that a gap between the two workpieces was not greater than 0.1 mm, thereby implementing an I-shaped joint. The backing plate was placed on the back of the butt joint and compressed together.

(3) Welding preparation: The butt-jointed and compressed workpieces to be welded were placed in a vacuum chamber of a welding machine, and the vacuum chamber of the welding machine was vacuumized to make a vacuum degree in the vacuum chamber less than 1×10⁻⁴ mbar.

(4) Preheating welding: Electron beam defocusing preheating was performed on the butt joint to be welded, where a welding speed during preheating was 10 mm/s, a focused beam current was 2300 mA, an electron beam current was 10 mA, electron beam deflection scanning was performed in a sine wave mode with a scanning amplitude of 5 mm and a frequency of 500 Hz, and an accelerating voltage was 150 kV.

(5) Tack welding: Waiting was performed for 5 min after the preheating welding, and symmetrical tack welding was performed on the butt joint to be welded, where a welding speed during tack welding was 15 mm/s, a focused beam current was 2100 mA, an electron beam current was 5 mA, and an accelerating voltage was 150 kV.

(6) Deep penetration welding: Waiting was performed for 15 min after the tack welding, and then deep penetration welding was performed on the butt joint to be welded, where a welding speed of the deep penetration welding was 5 mm/s, a focused beam current was 2050 mA, an electron beam current was 5 mA, electron beam deflection scanning was performed in a circular wave mode with a scanning amplitude of 0.5 mm and a frequency of 100 Hz, and an accelerating voltage was 150 kV.

(7) A welded molded part was cooled in the vacuum chamber for at least 60 min, and then vacuumized to obtain a welded molded part.

### Comparative Example 1

In this comparative example, two pieces of ultrahigh manganese TWIP steel were in butt joint as workpieces to be welded for conventional argon arc welding. Before welding, the two pieces of ultrahigh manganese TWIP steel were in an annealed state. A welded joint after the argon arc welding had a tensile strength of 737-921 MPa and an elongation after fracture of 20.07%-28.79%.

Finally, it should be noted that the above examples are provided merely to describe the technical solutions of the present disclosure, rather than to limit the protection scope of the present disclosure. Although the present disclosure is described in detail with reference to preferred examples, a person of ordinary skill in the art should understand that modifications or equivalent replacements may be made to the technical solutions of the present disclosure without departing from the essence and scope of the technical solutions of the present disclosure.

1. A method for vacuum electron beam welding of twinning-induced plasticity (TWIP) steel, comprising the following steps:
(1) welding preparation, comprising: placing butt-jointed TWIP steel workpieces in a vacuum chamber of a welding machine, and vacuumizing the vacuum chamber of the welding machine until a vacuum degree in the vacuum chamber is less than 1×10⁻⁴ mbar;
(2) preheating welding, comprising: performing electron beam defocus preheating on a butt joint of the TWIP steel workpieces, wherein the electron beam defocus preheating process is carried out with the following parameters: a welding speed of 5-10 mm/s, a focused beam current of 2,300-2,600 mA, an electron beam current of 10-30 mA, electron beam deflection scanning in a sine wave mode with a scanning amplitude of 2-5 mm and a frequency of 500-1,000 Hz, and an accelerating voltage of 150 kV;
(3) tack welding, comprising: performing symmetrical tack welding on a butt joint of the TWIP steel workpieces subjected to the preheating welding, wherein the symmetrical tack welding process is carried out with the following parameters: a welding speed of 5-15 mm/s, a focused beam current of 2,100-2,400 mA, an electron beam current of 2-5 mA, and an accelerating voltage of 150 kV;
(4) deep penetration welding, comprising: performing deep penetration welding on the butt joint of the TWIP steel workpieces subjected to the tack welding, wherein the deep penetration welding process is carried out with the following parameters: a welding speed of 5-15 mm/s, a focused beam current of 2,050-2,350 mA, an electron beam current of 5-50 mA, electron beam deflection scanning in a circular wave mode with a scanning amplitude of 0.5-2 mm and a frequency of 50-1,000 Hz, and an accelerating voltage of 150 kV; and
(5) cooling the TWIP steel workpieces subjected to the deep penetration welding to obtain a welded molded part, wherein
in steps (2)-(4), an interval between the preheating welding, the tack welding and the deep penetration welding is 5-15 min; and
the chemical composition of the TWIP steel workpieces in step (1) is as follows: by mass percentage, 0.6%-0.9% of C, 20%-30% of Mn, 0.3%-1.0% of Si, 0.3%-1.0% of Al, ≤0.015% of P, ≤0.005% of S, 0.3%-0.6% of V, 0.2%-0.5% of Nb, ≤0.1% of impurities, and the balance Fe.

2. The method for vacuum electron beam welding of TWIP steel according to claim 1, wherein the TWIP steel workpieces in step (1) have a thickness of 2-10 mm, a length of 100-200 mm and a width of 100-200 mm.

3. The method for vacuum electron beam welding of TWIP steel according to claim 1,
wherein in step (2), the electron beam defocus preheating process is carried out with the following parameters: a welding speed of 10 mm/s, a focused beam current of 2,510 mA, an electron beam current of 10 mA, a scanning amplitude of 4 mm, and a frequency of 600 Hz.

4. The method for vacuum electron beam welding of TWIP steel according to claim 1, wherein in step (3), the symmetrical tack welding process is carried out with the following parameters: a welding speed of 10 mm/s, a focused beam current of 2,310 mA, and an electron beam current of 3 mA.

5. The method for vacuum electron beam welding of TWIP steel according to claim 1, wherein in step (4), the deep penetration welding process is carried out with the following parameters: a welding speed of 10 mm/s, a focused beam current of 2,300 mA, an electron beam current of 20 mA, a scanning amplitude of 0.8 mm, and a frequency of 200 Hz.

6. The method for vacuum electron beam welding of TWIP steel according to claim 1, wherein in step (1), the workpieces are butt-jointed in an I-shaped butt joint, and a gap of the butt joint does not exceed 0.1 mm.

7. A welded molded part, wherein the welded molded part is obtained by using the method for vacuum electron beam welding of TWIP steel according to claim 1.

8. Manufacture method of a lightweight energy-absorbing buffer component of a vehicle, comprising using the welded molded part according to claim 7.

9. The method for vacuum electron beam welding of TWIP steel according to claim 2, wherein in step (2), the electron beam defocus preheating process is carried out with the following parameters: a welding speed of 10 mm/s, a focused beam current of 2,510 mA, an electron beam current of 10 mA, a scanning amplitude of 4 mm, and a frequency of 600 Hz.

10. The method for vacuum electron beam welding of TWIP steel according to claim 2, wherein in step (3), the symmetrical tack welding process is carried out with the following parameters: a welding speed of 10 mm/s, a focused beam current of 2,310 mA, and an electron beam current of 3 mA.

11. The method for vacuum electron beam welding of TWIP steel according to claim 2, wherein in step (4), the deep penetration welding process is carried out with the following parameters: a welding speed of 10 mm/s, a focused beam current of 2,300 mA, an electron beam current of 20 mA, a scanning amplitude of 0.8 mm, and a frequency of 200 Hz.

12. The method for vacuum electron beam welding of TWIP steel according to claim 2, wherein in step (1), the workpieces are butt-jointed in an I-shaped butt joint, and a gap of the butt joint does not exceed 0.1 mm.
